(19) United States
(12) Patent Application Publication
(10) Pub. No.: US 2012/0143695 A1
(43) Pub. Date: Jun. 7, 2012

(54) CONTENT COLLABORATION AMONG HETEROGENEOUS DISTRIBUTED MEDIUMS

(76) Inventors: Thyaga NANDAGOPAL, Edison, NJ (US); Ajay Sathyanath, Edison, NJ (US)

(21) Appl. No.: 12/961,833

(22) Filed: Dec. 7, 2010

(51) Int. Cl. G06Q 30/00

(52) U.S. Cl. 705/14.66; 705/14.49

(57) ABSTRACT

A system, an arrangement and a method for tracking viewership of regional billboards to collaborate billboard displays. Viewership is tracked using triggers that may be displayed with content and/or ads. Execution of the triggers may provide feedback to collaborate content/ads across billboards on a single medium or a number of heterogeneous media types to maximize cumulative viewership and advertising effectiveness. Triggers may be tailored to track the physical location of the billboard (in any display media), the time the billboard is displayed, and the identity of the content and/or ad. Data relating to the executed triggers includes identifying information of the viewer that executes the trigger to determine the success of the trigger. Following a determination of the success of the trigger, cumulative viewership of content, ads and triggers may be managed across billboards distributed across a region and across heterogeneous media.

### BACKGROUND OF THE INVENTION

1. Field of the Invention

Example embodiments relate generally to a system, an arrangement and a method for providing content and/or advertisement collaboration among different distributed mediums through the use of triggers embedded in the content. The triggers may be embedded within an advertisement that is displayed with content, or may be displayed only with content or only with an advertisement.

2. Related Art

Billboards and other advertising media today are discrete hardware or software structures that operate independently of each other to display messages and/or advertising. Billboards may include physical structures, or they may include content and advertisement on the internet websites, television, cell phones, newspapers (print or online), magazines, movie theatres, etc. Conventionally, billboard operators own and operate multiple billboards in a geographic region, where each individual billboard shows a single continuous advertisement or message (or, some content with an ad). Some limited methods of collaboration include triggers limited to tracking the identity of viewer SMS/phone numbers which are limited to tracking viewership of a single advertisement. However, the location of the billboard and the precise time at which the billboard is viewed is generally not tracked in conjunction with identifying information of the viewer audience. Furthermore, no collaboration is currently used between the billboards (whether the collaboration is between billboards of a same medium, or of heterogeneous media). Specifically, data from one billboard is not used to influence what is displayed on another billboard. Additionally, no tracking of viewer profiles and/or viewer identity is currently used to track viewers/consumers across various heterogeneous media types. Therefore, a maximization of cumulative viewership of all content/ads over all billboards in a region is not realized.

### SUMMARY OF INVENTION

Example embodiments provide a system/arrangement and a method for tracking viewership of content and advertisements across regional billboards using triggers. The triggers may provide feedback to collaborate content/ads across a single medium or a number of heterogeneous media types to maximize cumulative viewership and advertising effectiveness. The tracking of the viewership may be accomplished via embedded triggers tailored to the physical location of the billboard (in any display media), the time a particular content and/or ad is displayed on the billboard, the identity of the content and/or ad, and identifying information of the viewer (including a total number of viewers, interests and/or consumer preferences of individual viewers, generally interests of groups of viewers, frequency of viewership, other billboards viewed by a viewer, etc.). The triggers may be independent of the actual content or the ad. By associating the identity of the trigger with identification of the viewer, the identity of the content and/or ad on the billboard, the location of the billboard, and the time the billboard was actually viewed, the billboard operator can track viewership regardless of when the trigger was actually executed. By collecting this data, the cumulative viewership of content/ads may be managed across billboards distributed across a region and across heterogeneous media.

### BRIEF DESCRIPTION OF THE DRAWINGS

The above and other features and advantages of example embodiments will become more apparent by describing in detail, example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a content collaboration arrangement including a content collaboration system, in accordance with an example embodiment; and

FIG. 2 is a billboard showing a general relationship between a main content, a contextual advertisement and a trigger, in accordance with an example embodiment

### DETAILED DESCRIPTION

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

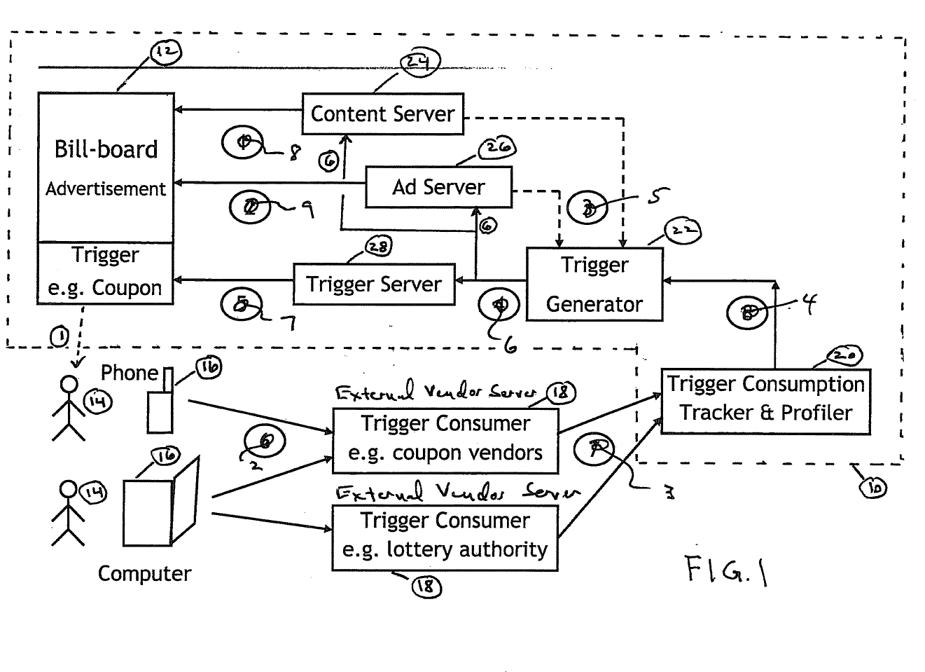

FIG. 1 is a content collaboration arrangement including a content collaboration system 10, in accordance with an example embodiment. The arrangement includes various billboards 12 containing content and/or advertising. A billboard 12 includes any structure, software and/or hardware capable of displaying images and messages on a medium for viewing by a target audience. A billboard may be a physical structure, such as billboards that are commonly found along interstates, shopping malls and movie theatres. A billboard may also include a website, a banner on a website (such as an advertisement banner), or a distributed email that may be transmitted to consumers or the general public. Furthermore, a billboard may include advertisements or messages on television or part of the trailer of a movie. Furthermore, a billboard may be an advertisement or message on a cell-phone or tablet. Furthermore, a billboard may be a newspaper or magazine (either in print or on-line). The definition of “billboard” is not limited by these examples, as the intended meaning of this term envelopes any means of displaying images and messages to a viewer.

The billboard 12 may display a trigger. The trigger may take a number of forms. For instance, the trigger may be a redeemable coupon with a specific coupon number (serial number) or it may be a game cheat code with an identifiable number that may be used in a computer game. A trigger may lend itself to identifying the viewer or the user that executes the trigger. The trigger may be related to the content/ad (for instance, the content/ad may be for a brand of coffee, and the trigger may be a redeemable coupon for a free cup of coffee) or the trigger may be unrelated to the content/ad (for instance, the content/ad may be for a brand of coffee, and the trigger may be a game cheat code of a computer game).

Viewers 14 may see the content/ad as well as seeing the trigger 1. Viewers may then use any number of devices 16 such as a cell phone or a laptop computer to then execute the trigger 2. Alternatively, devices 16 are not necessarily needed to execute triggers. For instance, using the example of the redeemable coffee coupon, a viewer 14 may use a computer 16 to access the coffee manufacturer's website (an external vendor server 18) to enter a coupon number to have a free sample of coffee shipped to the viewer. Alternatively, the viewer 14 may email the manufacturer (again accessing vendor server 18) to provide the coupon number. Furthermore, the viewer 14 may use a cell phone 16 to text the coupon number to a vendor phone number (used in conjunction with a vendor server 18 used to track the exchanges). Or the viewer 14 may provide a coupon number or serial number to a vendor server 18 to then enter the viewer in a lottery drawing. Additionally, rather than using a device 16, the viewer 14 may instead walk into a coffee shop and redeem the coffee coupon in which case the transaction associated with the redemption of the coupon is stored/tracked by the vendor server 18. Using any of these methods of executing a trigger 2, the vendor server 18 obtains both identifying information associated with the trigger itself (i.e., a coupon with unique identifying numbers/letters/symbols) as well as identifying information of the viewer. Identifying information of the viewer may include the viewer's phone number, home address, email address, IP address, or other types of contact information. Identifying information of the viewer may also include demographic information such as their age, occupation, citizenship, school district, their affiliation to various groups or organizations, or any other identifying information that may be of interest to a billboard operator. Identifying information may further include consumer preferences such as their interest in a full-sized versus compact car, their needs associated with value versus cost of consumer goods, or their favorite name brands. Identifying information may also include personal information such as a viewer's driver's license number, social security number, height and weight, etc.

Once the vendor server 18 has collected identifying information on both the trigger and the viewer, this data 3 may then be transmitted to a trigger consumption tracker and profiler 20 within a content collaboration system 10. The tracker/profiler 20 may compile data related to an identity of executed triggers that have been displayed on billboards across a region and across heterogeneous media. Because each trigger has a unique identifier, the tracker/profiler 20 may become aware of the precise time and location upon which the billboard was viewed. Identifying information of the trigger may be thought of as meta-data. For instance, a unique trigger identification number may be changed every one hour on a movie advertisement billboard such that viewership as a function of time (i.e., 12:00 p.m. to 1:00 p.m., 3:00 a.m. to 4:00 a.m.) may then be tracked. A unique identifier may be provided for billboards in train stations which may be different from billboards at a local mall. A unique identifier for internet advertisements may be different from billboards posted on a highway overpass. In each instance, the trigger may include a unique identifier able to identify the location and specific media used to display a trigger (i.e., the unique identifier identifies the geographic location of the billboard, and the media upon which the billboard was displayed such as the internet, television, a specific television show or movie, a physical billboard, etc.) and the time upon which the trigger was displayed (i.e., a specific time slot, date, season, year, etc. upon which the trigger was shown on the billboard).

The tracker/profiler 20 may provide tracking/profiling information 4 on identifying information associated with the trigger and the viewer to a trigger generator 22. The tracker/profiler 20 and the trigger generator 22 may be separate components or they may be a same component. The tracker/profiler 20 and the trigger generator 22 may be hardware, software, or a combination of software/hardware with associated storage that may be run on a computer, a personal computer (PC), a main-frame computer, or a dedicated machine used solely to provide the functionality described in this document. Furthermore, the trigger consumption tracker/profiler 20 may take the place of the external vendor servers 18, rather than having external vendor servers 18 that are separate from the tracker/profiler 20.

The trigger generator 22 may combine the tracker/profiler 20 data with data on available content 5 (from a content server 24 of potential content that may be available to display) and data on available advertising 5 (from an ad server 26) to then generate a control signal 6. The control signal 6 may be sent to a trigger server 28 that contains a listing of available triggers. The control signal 6 may be used to command the trigger server to display a trigger 7 on one or more billboards 12 that may be displayed across a number of media. The control signal may also be used to command the ad server 26 and/or content server 24 to also display an ad and/or content on the billboards 12 as well. The control signal 6 may be generated based on a determination of the success of previously executed triggers which were included in previous billboards 12 with ads and/or content.

A determination of the “success” of previous triggers may include threshold statistical markers such as a determination of the percentage of executed triggers that were executed by a target demographic of viewers (i.e., if a particular media type is better at reaching a target demographic, a future shift in focus more triggers on that particular media type may be preferred). A determination of “success” may also be the way in which various heterogonous media may maximize revenue (i.e., if it is determined that a less expensive media was actually more successful in reaching consumers, a future shift in focus toward the less expensive media may be preferred). Likewise, “success” may be determined based on the overall number of executed triggers having been reached by a particular media type, or by a group of one or more billboards (i.e., if the number of desired executed triggers was reached, a future shift in using the billboards for other purposes may be preferred). Further, “success” may be determined based on the number of triggers executed in a certain period of time (i.e., if it is determined that 80% of all executed triggers for train stations occurred based on billboard postings between 10:00 a.m. and 5:00 p.m., a future shift in focus toward the use of triggers on billboards during those times may be preferred). Further, “success” may be determined based on the particular pairing of a trigger with a specific content and/or ad. For instance, if a particular trigger is “successful” independently of the identity of either the content or the ad, a future shift in using that particular trigger only with higher revenue advertisements may be preferred. Likewise, if particular triggers are found only to be “successful” when paired with a particular ad or content, a future shift in using the trigger only with the specific content and/or ad that causes the triggers success may be found to be preferred. It should be understood that the “success” of a trigger is generally subjective and therefore the feedback control of the content collaboration system 10 may be tailored to meet the specific needs of the billboard owner to increase viewership over specific locations, specific media types, and/or specific times to increase the overall effectiveness of the billboards 12. Furthermore, due to the subjective nature of the “success” of a trigger, an individual may manually determine the “success” of previously executed triggers and then manually initiate a control signal 6 to generate a new trigger.

Interrelationship of Content, Ads and Triggers

Now that a content collaboration has been described, a further discussion of the relationship between displayed contents, advertisement and triggers is described herein.

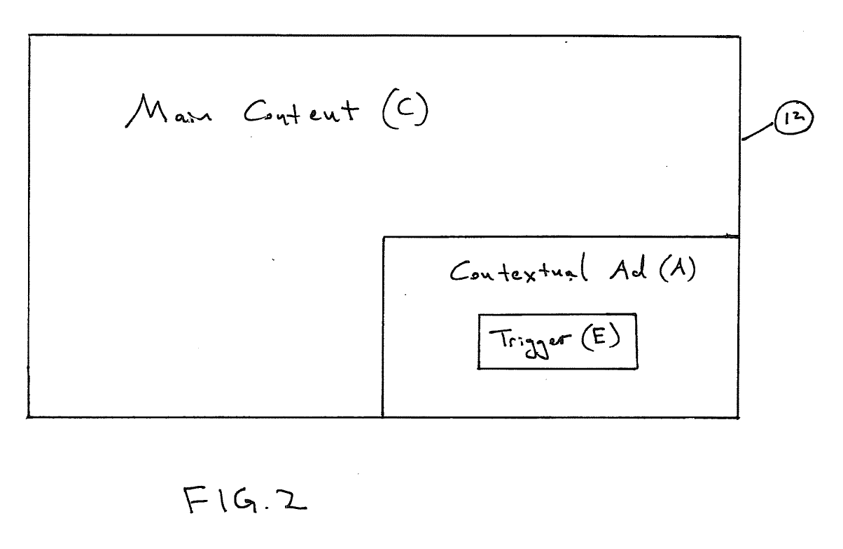

FIG. 2 is a billboard 12 showing the general relationship between a main content (C), a contextual advertisement (A) and a trigger (E), in accordance with an example embodiment. Specifically, the billboard 12 may include a main content (C) such as a public service message or a scenic photograph or a main content of an internet website. The billboard may also include a contextual ad (A). The ad (A) may be a smaller component of the content (C), such as a banner of a webpage that includes the advertisement. Alternatively, the main content (C) may not exist and the billboard 12 may only be the ad (A) itself. Alternatively, the billboard 12 may only include content (C) such as a public service message, and no ad (A) may exist. The trigger (E) may exist on the billboard as an identifying number or instructions specifying how a viewer may execute the trigger. Alternatively, the trigger (E) may be a field on an Internet website that a viewer may select to instantly execute the trigger. Furthermore, the trigger (E) may be a coupon that a viewer may print from a webpage to later redeem at a vendor's store.

It is important to note that the actual execution of the trigger (E) may occur at a location that is a distance away from the actual billboard (for instance, a trigger (E) included in a billboard at the state fair may be redeemed by viewers through their local school district). The actual execution of the trigger may also occur at a point in time that is much later than the actual viewing of the trigger (for instance, the trigger (E) included in the billboard at the state fair may execute by members of the school district at the end of the school year). Therefore, the trigger (E) may be executed at a point in time and a place in time that is very different from the initial viewing of the trigger (E) on the billboard 12 itself.

The following equation further describes the relationship between a trigger and the other parameters of the content collaboration system.

Eᵢⱼₖ=f(Aᵢ,Lⱼ,Cₖ,Tᵢⱼₖ) Equation 1

Aᵢ=ads in ad inventory (A₁, A₂, . . . , Aₘ)

Lⱼ=location of billboard (L₁, L₂, . . . , Lₙ)

Cₖ=content available in content inventory (C₁, C₂, . . . , C_{q})

Tᵢⱼₖ=time interval of Aᵢ shown at location Lⱼ with content Cₖ

Therefore, according to Equation 1, trigger Eᵢⱼₖ is a function of the time interval or time duration upon which ad Aᵢ is shown on billboard location Lⱼ along with content Cₖ.

To provide another specific example, Aᵢ may be a shoe ad, Cₖ may be a picture of a store where the shoe is available, and location Lⱼ may be a location of many billboards owned by a billboard owner that have been placed in internet advertisements, television advertisements, and various billboards within regional movie theatres and shopping malls in a geographic area. The goal of the billboard owner is to maximize cumulative viewership of all of the shoe ads Aᵢ across the billboards in the region during a period of time (the period of time Tᵢⱼₖ may be a first week of the shoe ad campaign). A group of people traveling through the mall may see several of the owner's billboards including the shoe advertisement Aᵢ. However, if each billboard in the region only displays the same shoe ad Aᵢ, the billboard owner loses revenue due to a reduced number of distinct ads for other products that could otherwise have been viewed by unique consumers. Furthermore, in some cases the billboard owner may purposefully want the same shoe ad Aᵢ to be seen by a consumer multiple times. However, without a means of tracking how many times the shoe ad Aᵢ has actually been seen, the effectiveness of the billboard may remain unknown.

Therefore, the billboard owner may provide a trigger to gauge the viewership and effectiveness of each billboard displaying the shoe ad Aᵢ. The trigger may be the same for each shoe ad Aᵢ among each of the heterogeneous media, or the trigger may be different for each type of media in order to track the effectiveness of the media type itself. For instance, trigger Eᵢⱼₖ for all internet ads (location Lⱼ being internet ads) may be a unique lottery number that a viewer may text using a cell phone, for a chance to win a sports car. The trigger E_{ifk} for all billboard ads within the mall (location L_{f} being mall ads) may also be a lottery number that a viewer may text using a cell phone for a same chance to win the sports car. The two triggers both ensure that a same viewer has an equal interest in executing the trigger, as the “prize” for both triggers is a chance to win the same “prize” (i.e., the sports car). However, the lottery number for the E_{ifk} trigger (the trigger for the mall ad) may be a different unique lottery number than the lottery number used for the internet ad. This will allow the billboard owner to track the effectiveness of the separate internet and mall advertisements. By obtaining feedback on the effectiveness of all content/ads placed in different locations at different times and using different heterogeneous media, the billboard owner may then use triggers to determine the effectiveness of location, time, and/or chosen media to then provide a collaborated billboard campaign.

Further Examples of Collaboration

Collaboration among triggers, content and ads can take various forms. Three major types of collaboration may be as follows.

1. Sectional Collaboration: Collaboration that limits itself to only a portion of all billboards. For instance, a trigger included in an ad, where the trigger may or may not be related to advertisement.

2. Embedded Sectional Collaboration: Embedded sectional collaboration refers to sectional collaboration that is further embedded inside another content. For instance, a trigger included in an ad that is embedded in content. The trigger may or may not be related to the content and/or the ad.

3. Exhaustive Collaboration: Collaboration that occupies the entire billboard. For instance, a billboard that only displays a trigger. A specific example of this may be a billboard that only includes information providing a coupon with a unique identifier for a free item at a local mall. Another example may include a content or an ad that may be displayed on the billboard as a direct result of an output of the trigger generator. In other words, the content/ad displayed on one particular billboard is the result of executed triggers involving one or potentially many other billboards.

Of the above examples of collaboration, embedded sectional collaboration is of particular interest. Embedded sectional collaboration increases the number of “keen eyeballs” because it provides viewers with a reason to seek out the embedded trigger and in doing so the viewers are actively seeking out the enveloping content and the ad. “Keen eyeballs” is a count of the number of viewers actively viewing and/or searching the billboard for information. Viewers with “keen eyeballs” are different from a great number of viewers nowadays that subconsciously or purposefully ignore and/or gloss over billboards as they are often desensitized from constant exposure to advertisements and messages throughout their daily lives. An increase in “keen eyeballs” on a billboard, rather than a mere increase in the number of eyeballs on a billboard, translates into a higher CPM (cost per mile) that may be charged for a particular ad.

Therefore, embedded sectional collaboration causes value to move from the trigger, to the ad containing the trigger, to the content containing the trigger and the ad (i.e., movement of value can move as follows: E (trigger)→A (ad)→C (content)). For this reason, selection of an embedded trigger may be based on the relevance of the embedded trigger as the trigger relates to the ad and/or the content.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A content collaboration system, comprising:
a trigger consumption tracker and profiler configured to compile data on an executed trigger,
the compiled data including an identity of the executed trigger and information on an identity of a viewer that executed the trigger,
the executed trigger having been displayed on a billboard.

2. The system of claim 1, wherein,
the compiled data further includes an unique identifier providing the identity of the executed trigger,
the unique identifier including information on at least one of a time, a location, a media type of the billboard, and an identity of a content/ad displayed on the billboard with the trigger.

3. The system of claim 2, wherein the identity of the viewer includes at least one of demographic information, consumer preferences, contact information and personal information.

4. The system of claim 1, wherein the trigger consumption tracker and profiler is configured to receive the data from external vendor servers.

5. The system of claim 3, further comprising:
a content server including a plurality of content available to be displayed on the billboard;
an ad server including a plurality of ads available to be displayed on the billboard; and
a trigger generator configured to receive information on the available content from the content server, available ads from the ad server, and the compiled data from the trigger consumption tracker and profiler,
wherein the trigger generator is configured to transmit a control signal to the trigger server to command the trigger server to display a trigger on the billboard.

6. The system of claim 5, wherein the trigger generator is also configured to transmit the control signal to at least one of the content server and the ad server to command the content server and the ad server to display content and/or ads on the billboard.

7. The system of claim 5, wherein the trigger generator generates the control signal based in part on a determination of the success of previously displayed and executed triggers.

8. The system of claim 1, wherein the billboard is any structure, software and/or hardware capable of displaying images and messages on a medium for viewing by the viewer, the viewer being a target audience.

9. The system of claim 8, wherein the billboard includes a plurality of billboards across a plurality of heterogeneous media types.

10. A content collaboration arrangement, comprising:
a billboard displaying an initial trigger;
an external vendor server configured to receive an executed initial trigger;
a trigger consumption tracker and profiler configured to compile data from the external vendor server, the compiled data including an unique identifier corresponding to the identity of the executed initial trigger and an identity of the user that executed the initial trigger;
a trigger generator configured to receive the compiled data from the trigger consumption tracker and profiler and to determine a success of the initial trigger, the trigger generator configured to generate a control signal based at least in part on the determined success of the initial trigger; and
a trigger server configured to receive the control signal, the trigger server configured to display another trigger on the billboard based on the control signal.

11. The arrangement of claim 10, further comprising:
a content server including a plurality of content available to be displayed on the billboard; and
an ad server including a plurality of ads available to be displayed on the billboard,
wherein the trigger generator is also configured to transmit the control signal to at least one of the content server and the ad server to command the content server and/or the ad server to display content and/or ads on the billboard.

12. A method of content collaboration, comprising:
displaying an initial trigger on a billboard;
compiling data on execution of the initial trigger, by a trigger consumption tracker/profiler, the compiled data including an unique identifier and information on an identity of a viewer that executed the initial trigger;
determining a success of the initial trigger based on the compiled data; and
displaying another trigger on the billboard based at least in part on the determined success of the initial trigger.

13. The method of claim 12, wherein the displaying of the initial trigger and the another trigger on the billboard includes displaying the triggers on a plurality of billboards over a plurality of heterogeneous media types.

14. The method of claim 12, wherein the compiling of the data includes corresponding the unique identifier with information on at least one of a time, a location, a media type, and an identity of a content/ad displayed on the billboard with the trigger.

15. The method of claim 12, wherein the compiling of the data includes compiling the information on the identity of the viewer which is one of demographic information, consumer preferences, contact information and personal information.

16. The method of claim 12, further comprising:
receiving the executed initial trigger at an external vendor server; and
transmitting information on the executed initial trigger to the trigger consumption tracker/profiler to then compile the data.

17. The method of claim 12, further comprising:
generating a control signal based on the determined success of the initial trigger;
transmitting the control signal to at least one of a trigger server, a content server and an ad server, wherein the displaying of the another trigger is accomplished by the trigger server.

18. The method of claim 18, further comprising:
displaying at least one of a content and an ad on the billboard with the another trigger based on the control signal, the content server being used to display the content and the ad server being used to display the ad.

19. The method of claim 12, wherein the displaying of the another trigger includes displaying the another trigger on another billboard.
